(19) United States
(12) Patent Application Publication
(10) Pub. No.: US 2024/0169252 A1
(43) Pub. Date: May 23, 2024

(54) ANOMALY MONITORING AND MITIGATION OF AN ELECTRIC SUBMERSIBLE PUMP

(71) Applicant: Halliburton Energy Services, Inc., Houston, TX (US)

(72) Inventors: Christina Marie Harrington, Tulsa, OK (US); Bobby Neal Armstrong, Tulsa, OK (US); Frank Corredor, Houston, TX (US)

(21) Appl. No.: 17/991,387

(22) Filed: Nov. 21, 2022

(51) Int. Cl. G06N 20/00; E21B 43/12; G08B 21/18

(52) U.S. Cl. CPC G06N 20/00; E21B 43/128; G08B 21/18

(57) ABSTRACT

A computer-implemented method for monitoring an electrical submersible pump (ESP) disposed in a wellbore. The method comprises obtaining ESP data from the ESP. The method comprises generating an alarm based on the ESP data. The method comprises performing the following after the alarm is generated, inputting the ESP data into a trained machine learning model and determining, with the trained machine learning model, an incident class based on the ESP data.

### FIELD

The disclosure generally relates to wellbores formed in subsurface formations, and in particular, artificial lift systems that include an electrical submersible pump (ESP) used to extract hydrocarbons from subsurface formations.

### BACKGROUND

In hydrocarbon recovery operations from a wellbore, an electrical submersible pump may be utilized to transport the hydrocarbons to the surface. Detecting anomalies in the ESP may be important to maximize hydrocarbon recovery. For example, the detection and type of anomalies in the ESP may be used to adjust the ESP operating settings and maximize hydrocarbon recovery from the surrounding subsurface formation.

### BRIEF DESCRIPTION OF THE FIGURES

Embodiments of the disclosure may be better understood by referencing the accompanying drawings.

FIG. 1 depicts an example well system with an electrical submersible pump (ESP), according to some embodiments.

FIG. 2 depicts a flowchart of example operations for generating an alarm for an ESP, according to some embodiments.

FIG. 3 is a continuation of FIG. 2 and depicts a flowchart of example operations for generating recommended mitigation activities, according to some embodiments.

FIG. 4 depicts a flowchart of example operations for configuring a classification machine learning model, according to some embodiments.

FIG. 5 depicts a flowchart of example operations for training a classification machine learning model, according to some embodiments.

FIG. 6 depicts a flowchart of example operations for determining an incident class, according to some embodiments.

FIG. 7 depicts an example computer, according to some embodiments.

### DESCRIPTION OF THE EMBODIMENTS

### Overview

In hydrocarbon production, an electrical submersible pump (ESP) disposed in a well may be utilized to produce fluids from a subsurface formation. As the ESP transports fluid to the surface, anomalies in the ESP may occur which may lead to damaging the ESP and/or a decrease in fluid production. Some implementations relate to utilizing machine learning to detect potential anomalies in the ESP and recommend activities to mitigate the potential anomalies.

Some implementations may obtain ESP data from an ESP positioned in a wellbore. Some implementations may utilize the ESP data to generate a health score of the ESP to indicate if the ESP may have an anomaly. For example, at least a portion of the ESP data may be utilized to generate predicted ESP data. In some embodiments, if the predicted ESP data deviate from the actual ESP data, then an anomaly may be present in the ESP. If an anomaly is detected, then an alarm may be generated. Examples of an anomaly may include high internal motor temperature, low motor current, low pump discharge pressure, etc. Some implementations may input the ESP data into a trained machine learning model when an alarm is generated. In other words, an alarm may be classified into one of a number of incidents. Examples of an incident may include gas interference, sand in the ESP, the wellbore is pumped off, etc. Therefore, the trained machine learning model may generate an incident class, based on the ESP data, to classify the anomaly. The incident class may be utilized to generate recommended activities to mitigate the anomaly. Additionally, the alarm type and severity may be updated based on the incident class. Thus, in some implementations, each incident class may have a defined alarm type and severity.

In some implementations, the alarm and recommended mitigation activities may be used to perform a wellbore operation. For example, a wellbore operation may be initiated, modified, or stopped based on the alarm and recommended mitigation activities. Examples of such wellbore operations may include increasing or decreasing the speed of the ESP, adjusting the mode in which the ESP is operating, adjusting flow control valves, shutting down the ESP, chemically treating the wellbore, etc. For instance, the incident class and alarm may indicate the intake pressure is below an operating threshold and the recommended mitigation activity may be adjusting the operation mode of the ESP. Accordingly, instructions to slow down the ESP may be communicated to a controller of the ESP.

### Example System

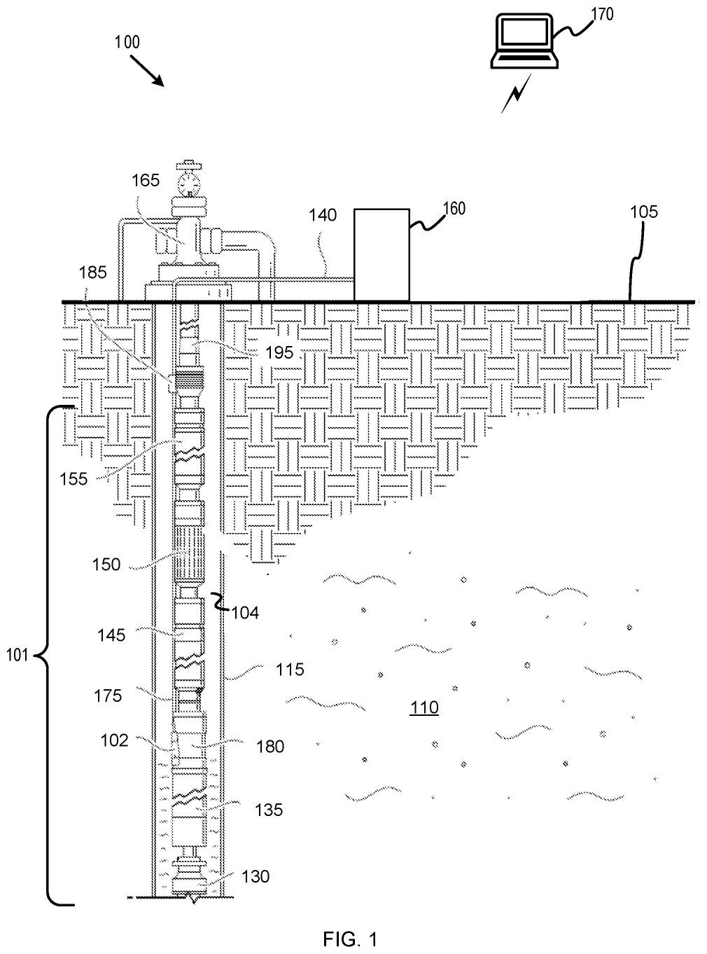

FIG. 1 depicts an example well system with an electrical submersible pump (ESP), according to some embodiments. While well system 100 illustrates a land-based subterranean environment, the present disclosure contemplates any well site environment including a subsea environment. In one or more embodiments, any one or more components or elements may be used with subterranean operations equipment located on offshore platforms, drill ships, semi-submersibles, drilling barges and land-based rigs.

An ESP assembly 101 is located downhole in a wellbore 104 below a surface 105. The wellbore 104 may, for example, be several hundred or a few thousand meters deep. The wellbore 104 is depicted as vertical, but it may also be horizontal or may be curved, bent and/or angled, depending on wellbore direction. The wellbore 104 may be an oil well, water well, and/or well containing other hydrocarbons, such as natural gas, and/or another production fluid taken from a subsurface formation 110. The ESP assembly 101 may be separated from the subsurface formation 110 by a well casing 115. Production fluid enters the well casing 115 through casing perforations (not shown). Casing perforations may be either above or below an ESP intake 150. The ESP assembly 101 includes, from bottom to top, a downhole gauge 130 which may include one or more sensors that may detect and provide information such as motor speed, internal motor temperature, pump discharge pressure, downhole flow rate and/or other operating conditions to a user interface, variable speed drive controller, and/or data collection computer, herein individually or collectively referred to as controller 160, on surface 105. An ESP motor 135 may comprise an induction motor, such as a two-pole, three phase squirrel cage induction motor and a permanent magnet motor. An ESP cable 140 may be communicatively coupled to the controller 160. The ESP cable 140 may provide power to the ESP motor 135 and/or carries data to and/or from the downhole gauge 130 to the surface 105.

Upstream of the ESP motor 135 is a motor protector 145, an ESP intake 150, an ESP pump 155 and a production tubing 195. The motor protector 145 may serve to equalize pressure and keep the motor oil separate from well fluid. The ESP intake 150 may include intake ports and/or a slotted screen and may serve as the intake to the ESP pump 155. The ESP pump 155 may comprise a multi-stage centrifugal pump including stacked impeller and diffuser stages. Other components of ESP assemblies may also be included in the ESP assembly 101, such as a tandem charge pump (not shown) or gas separator (not shown) located between the ESP pump 155 and the ESP intake 150 and/or a gas separator that may serve as the pump intake. Shafts of the ESP motor 135, the motor protector 145, the ESP intake 150 and the ESP pump 155 may be connected (i.e., splined) and rotated by the ESP motor 135. The production tubing 195 may carry lifted fluid from the discharge of the ESP pump 155 toward a wellhead 165.

The ESP cable 140 extends from the controller 160 at surface 105 to a motor lead extension (MLE) 175. A cable connection 185 connects the ESP cable 140 to the MLE 175. The MLE 175 may plug in, tape in, spline in or otherwise electrically connect the ESP cable 140 to the ESP motor 135 to provide power to the ESP motor 135. A pothead 102 encloses the electrical connection between MLE 175 and a head 180 of the ESP motor 135.

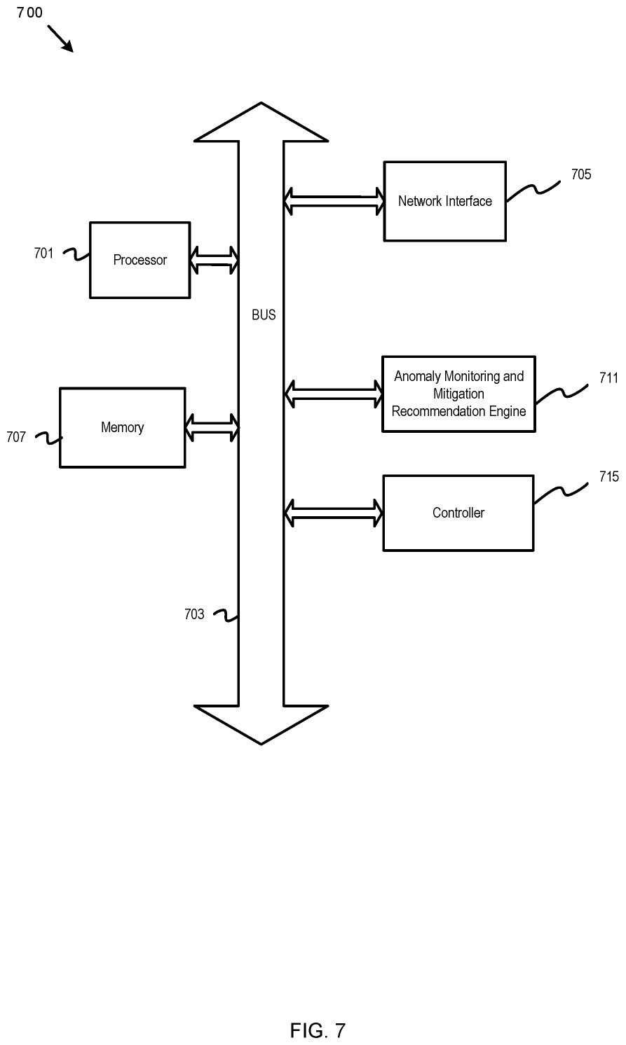

The well system 100 includes a computer 170 that may be communicatively coupled to other parts of the well system 100 such as the controller 160, pressure sensors, flow meters, etc. The computer 170 can be local or remote to the well system 100. A processor of the computer 170 may perform simulations (as further described below) that detect anomalies in the ESP assembly 101. Additionally, the processor of the computer 170 may determine the type of incident that caused the anomaly, and recommend activities to mitigate the incident. In some embodiments, the processor of the computer 170 may control operations of the well system 100. An example of the computer 170 is depicted in FIG. 7, which is further described below.

### Example Operations

This section describes operations associated with some implementations of the invention. In the discussion below, the flow diagrams may be described with reference to the example system presented above. In certain implementations, the operations are performed by executing instructions residing on machine-readable media (e.g., software), while in other implementations, the operations are performed by hardware and/or other logic (e.g., firmware). In some implementations, the operations are performed in series, while in other implementations, one or more of the operations can be performed in parallel. Moreover, some implementations perform less than all the operations shown in the flow diagrams.

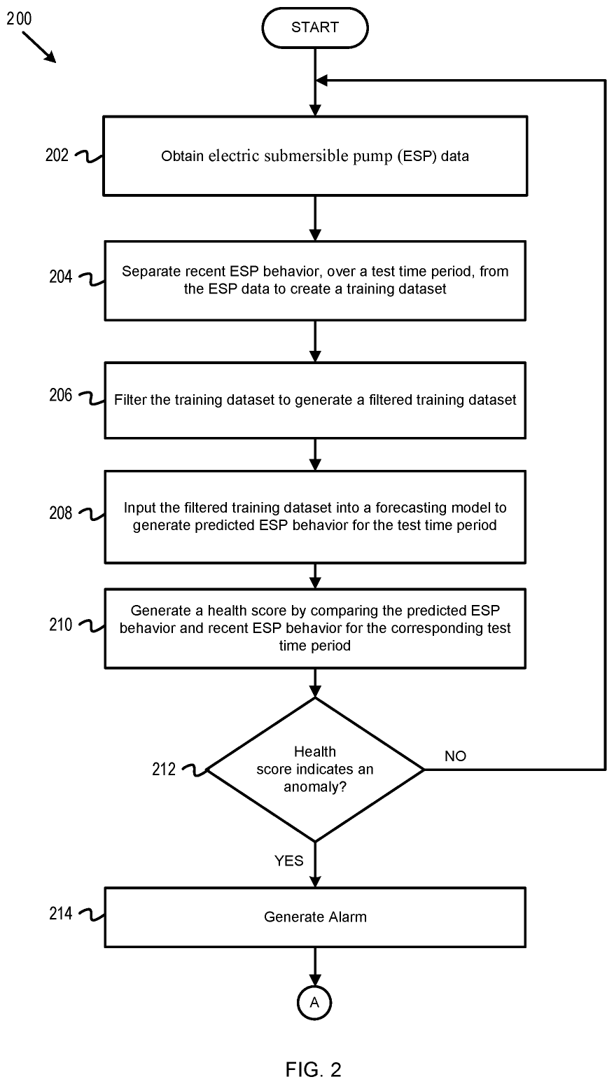

FIG. 2 depicts a flowchart of example operations for generating an alarm for an ESP, according to some embodiments. Operations of the flowchart 200 of FIG. 2 are described in reference to the computer 170 of FIG. 1. The computer 170 may perform any or all of the operations described with reference to FIG. 2. Operations of the flowchart 200 start at block 202.

At block 202, electric submersible pump (ESP) data may be obtained. For example, with reference to FIG. 1, a processor of the computer 170 may perform this operation. For example, the downhole gauge 130 (i.e., the sensor) of FIG. 1 may detect information about the ESP and communicate it to the computer 170 via the controller 160. ESP data may also be obtained from other sources such as the manufacturer of the ESP, sensors coupled to the wellbore, wellhead, or production equipment, etc. ESP data may include operation parameters such as motor speed. The ESP data may also include equipment parameters such as motor size, number of stages, etc. The ESP data may also include performance parameters that may correspond with the operation parameters and equipment parameters. The performance parameters may include downhole data (i.e., include internal motor temperature, pump discharge pressure, pump intake pressure, downhole flow rate, etc.), surface data (i.e., casing pressure, well head pressure, flow control valve position, etc.), and controller data (i.e., motor speed, motor current, etc.). The performance parameters may indicate how the ESP behaves relative to the operation parameters and equipment parameters. For example, if an ESP motor speed is increased from 55 hertz (Hz) to 57 Hz, then the internal motor temperature may also increase, and the pump intake pressure may decrease. In some embodiments, production data associated with the wellbore may be included in the ESP data. The operations parameters and performance parameters of the ESP data may be in the time domain. The ESP data obtained may comprise ESP data over a period of time such as 1 hour, 24 hours, 1 week, etc. The ESP measurements over a time period may be various frequencies such as every 15 second, 1 minute, 1 hour, etc.

At block 204, the recent ESP behavior, over a test time period, may be separated from the ESP data to create a training dataset. For example, with reference to FIG. 1, a processor of the computer 170 may perform this operation. A time period within the ESP data may be selected as the test time period. For instance, the ESP data may include ESP data taken over a 24-hour period. The most recent hour of the 24-hour period may be selected as the test time period. The ESP data corresponding to the test time period may be separated from the ESP data and designated as the recent ESP behavior. The recent ESP behavior may include the operation and equipment parameters with corresponding performance parameters over the test time period. For example, the recent ESP behavior may include the operation and equipment parameters and corresponding performance parameters for the most recent hour (i.e., the test time period) of the 24-hour period as described above. In some embodiments, the recent ESP behavior may only include time series data (i.e., operation parameters and performance parameters).

The remaining ESP data (i.e., the ESP data that is not associated with the test time period) may be designated as the training dataset. For example, the training dataset may include the ESP data for the first 23 hours of the 24-hour period described above. The training dataset may include time series data (i.e., operation parameters and performance parameters) and categorical data (i.e., equipment parameters) of the ESP data. The training dataset may be utilized to train a forecasting model configured to generate predicted ESP behavior based on features including operation parameters, equipment parameters, and performance parameters. In some embodiments, the forecasting model may also utilize other features such as production rates, tubing pressure, casing pressure, fluid temperature, etc.

At block 206, the training dataset may be filtered to generate a filtered training dataset. For example, with reference to FIG. 1, a processor of the computer 170 may perform this operation. In some embodiments, the training dataset may be processed (e.g., filtered) to remove outlier behavior. For instance, techniques such as smoothing may be applied to the training dataset to filter out noise in the dataset.

At block 208, the filtered training dataset may be input into a forecasting model to generate predicted ESP behavior for the test time period. For example, with reference to FIG. 1, a processor of the computer 170 may perform this operation. The filtered training dataset (as described in block 204) of the ESP data may train the forecasting model to generate predicted ESP behavior for the test time period based on the operation and equipment parameters and the corresponding performance parameters of the ESP. Once trained, the forecasting model may generate a predicted ESP behavior for the test time period. The predicted ESP behavior may include time series data including predicted performance parameters (such as internal motor temperature, motor current, intake pressure, discharge pressure, etc.), and predicted operation parameters as well as predicted equipment parameters for the test time period. The predicted ESP behavior may indicate the approximate performance parameter values and operation parameter values during the test time period based on the filtered training dataset. For example, the training dataset may indicate that a motor has an internal motor temperature of 180 degrees Fahrenheit when operating at 55 Hz. Therefore, the forecasting model may predict the internal motor temperature to be approximately 180 degrees Fahrenheit if the motor is running at 55 Hz during the test time period.

At block 210, a health score may be generated by comparing the predicted ESP behavior and the recent ESP behavior for the corresponding test time period. For example, with reference to FIG. 1, a processor of the computer 170 may perform this generation. The predicted ESP behavior and the recent ESP behavior may be compared utilizing attributes such as a prediction interval, correlation, distance metrics, etc. For example, a prediction interval of 95% confidence may be used to indicate the forecasting model is 95% certain the ESP behavior from the test time period should fall within the prediction interval. If it does not, this may be reflected in the generated health score as potentially anomalous behavior. In some embodiments, a Euclidean distance may be utilized as a distance metric to compare the recent and predicted behavior. The health score may include the comparison values (generated by the various comparison attributes) for each of the performance parameters in the ESP behaviors. For instance, the health score may indicate the magnitude of the difference between the performance parameters associated with the test time period and the predicted performance parameters generated by the forecasting model such as internal motor temperature, motor current, pump intake pressure, etc. The health score may be utilized to determine if there is an anomaly in the ESP. For example, a difference between the recent ESP behavior and the predicted ESP behavior may indicate (according to a distance metric) there may be an anomaly in the ESP that may be causing the ESP to behave differently than how it may have historically behaved. In some embodiments, multiple comparison attributes may be used together, and the attributes may affect the health score. For example, if both a prediction interval and a Euclidean distance metric is used, both may have a weighted effect on the health score, potentially reinforcing the reliability of the alarm generation.

At block 212, a determination may be made if a health score indicates an anomaly. For example, with reference to FIG. 1, a processor of the computer 170 may perform this operation. For instance, if the comparison of the ESP behaviors produces a health score with one or more performance parameters that are outside of a prediction interval and/or greater than distance metrics, then this may indicate an incident may have occurred during operations, warranting an alarm. For example, if a health score includes a difference between a predicted performance parameter and a recent performance parameter that is greater than a predetermined Euclidean distance, then an anomaly may be present in the ESP, warranting an alarm to be generated. If the health score indicates an anomaly, then operations proceed to block 214. Otherwise, operations return to block 202 to continue obtaining ESP data to observe and/or evaluate the ESP behavior.

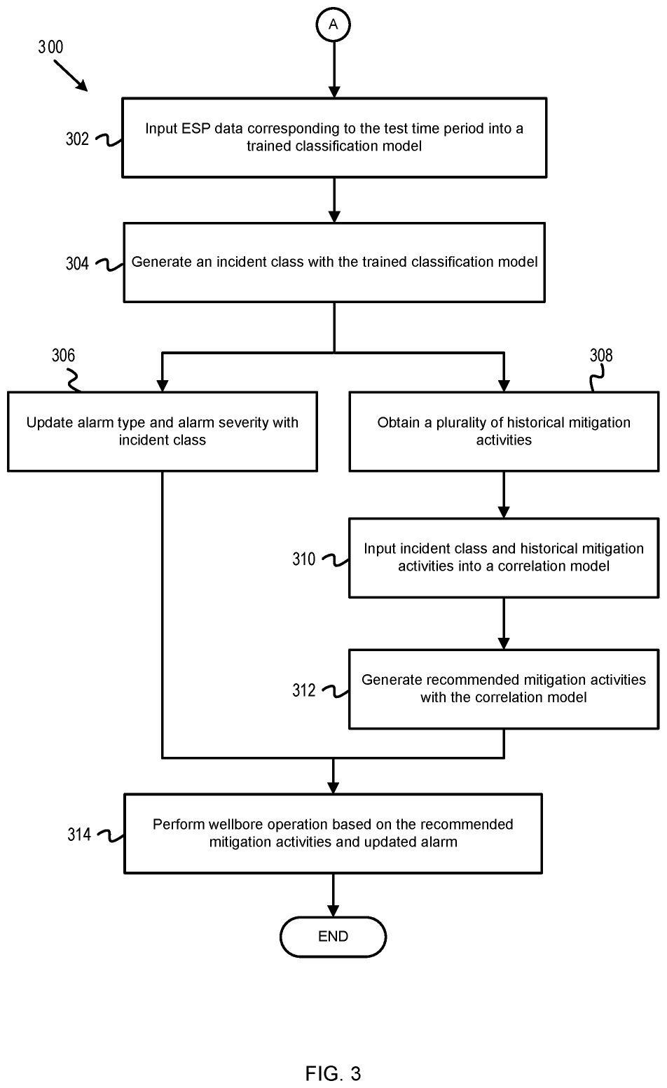

At block 214, an alarm may be generated. For example, with reference to FIG. 1, a processor of the computer 170 may perform this generation. The alarm may include the ESP data that did not meet the requirements described in block 210. For instance, performance parameters with a difference greater than a specified Euclidean distance may be included in the alarm. In some embodiments, more than one type of alarm may be generated. For instance, a pump intake pressure alarm and a motor current alarm may be generated from the ESP data. Additionally, the severity of the alarm may depend on the comparison between the predicted ESP behavior and the recent ESP behavior. For example, the severity of the alarm may increase as the difference between the performance parameters increases. The severity may also depend on the ESP data. For example, the severity for a low motor current alarm may be greater than a high casing pressure alarm. Operations of the flowchart 200 are continued on FIG. 3.

FIG. 3 is a continuation of FIG. 2 and depicts a flowchart of example operations for generating recommended mitigation activities, according to some embodiments. Operations of the flowchart 300 of FIG. 3 are described in reference to the computer 170 of FIG. 1. The computer 170 may perform any or all of the operations described with reference to FIG. 3. Operations of the flowchart 300 start at block 302.

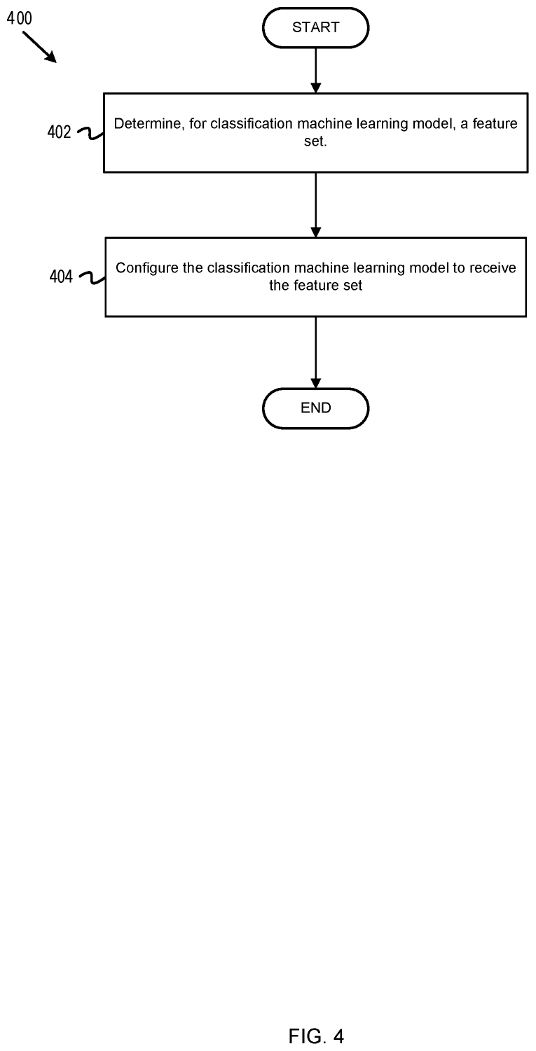

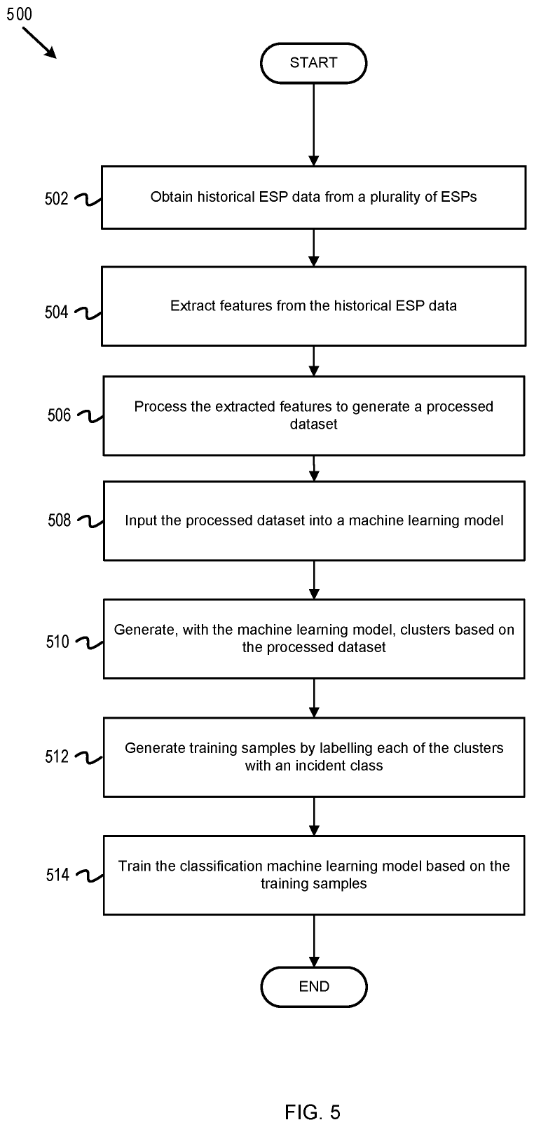

At block 302, ESP data corresponding to the test time period may be input into a trained classification model. For example, with reference to FIG. 1, a processor of the computer 170 may perform this operation. The ESP data corresponding to the test time period may include the operation and equipment parameters and the corresponding performance parameters for the test time period. The trained classification model will be described in FIGS. 4 and 5.

At block 304, an incident class may be generated with the trained classification model. For example, with reference to FIG. 1, a processor of the computer 170 may perform this operation. The incident class may indicate what may have caused the anomaly in the ESP data. An incident class may include incidents associated with well conditions such as gas interference, sand issues, etc. Incident classes may include incidents associated with equipment issues such as worn stages, motor over/underload, broken shaft, etc. An incident class may include incidents associated with tubing conditions such as plugged tubing, hole in tubing, etc. An incident class may include incidents associated with surface conditions such as flow control valve issue, high casing pressure, flow line issue, etc. An incident class may include incidents associated with controller issues such as incoming power issues, ground cable, etc. In some embodiments, the trained classification model may generate multiple incident classes. For example, the trained classification model may output a broken shaft incident and a worn stages incident. In some instances, the trained classification model may provide a probability with each of the incident classes that may be output. For example, the trained classification model may indicate the incident may be due to well conditions and that there is a 75% probability that the incident may be a pump off incident and a 25% probability that the incident may be gas interference.

At block 306, the alarm type and alarm severity may be updated with the incident class. For example, with reference to FIG. 1, a processor of the computer 170 may perform this operation. The alarm may be updated to include the possible incident classes generated by the trained classification model. For instance, an alarm may be updated to include the incidents that may have caused the anomaly and the probability associated with each instance. For example, a low motor current alarm may be updated with a gas interference incident and a worn stages incident, and the 75% and 25% probability, respectively, of each of the incidents that may have caused the anomaly. Additionally, the alarm severity may be updated based on the incident class. For instance, an incident indicating immediate action may need to be taken may increase the severity of the alarm. In some embodiments, either the alarm type or the alarm severity, neither the alarm type or the alarm severity, or both the alarm type and the alarm severity may be updated based on the incident class.

At block 308, a plurality of historical mitigation activities may be obtained. For example, with reference to FIG. 1, a processor of the computer 170 may perform this operation. Historical mitigation activities may comprise actions that may be taken in response to an incident that may have occurred in the ESP system to potentially mitigate the incident. The plurality of historical mitigation activities may have a corresponding incident class. For example, an incident class of gas interference may correspond to a mitigation activity of adjusting a flow control valve. Historical mitigation activities may be associated with ESPs of various sizes and ESPs in the same and different subsurface formations. Mitigation activities may include remote activities (i.e., activities that may be communicated from the processor of the computer 170 to the ESP via the controller) such as adjusting the motor speed, changing the mode of operation (i.e., constant frequency mode to a proportional integral derivative (PID) mode), etc. Mitigation activities may include manual activities (i.e., activities performed at or near the wellbore) such as adjusting a flow control valve, chemically treating the well, etc. Mitigation activities may include a combination of remote activities and manual activities. For example, if it has been determined that an ESP has a scale issue, instructions may be communicated to the ESP via the controller to perform one or more operations to free the ESP of any scale that may be prohibiting the stages of the ESP from rotating. Additionally, an operator may chemically treat the wellbore and ESP to potentially mitigate scale in the wellbore and/or ESP. In some embodiments, the historical mitigation activities may include a quantity in which the adjustments to operation parameters and other settings corresponding to the ESP may be made. For example, a mitigation activity may include adjusting an operation parameter by a percentage (i.e., 5% of the current operation parameter), adjusting to a defined level (i.e., adjusting the motor speed to a frequency of 55 Hz), etc.

At block 310, the incident class and historical mitigation activities may be input into a correlation model. For example, with reference to FIG. 1, a processor of the computer 170 may perform this operation. The correlation model may include a statistical correlation model, a machine learning model, etc.

At block 312, recommended mitigation activities may be generated with the correlation model. For example, with reference to FIG. 1, a processor of the computer 170 may perform this operation. The correlation model may be configured to generate recommended mitigation activities based on the incident class and historical mitigation activities. For instance, the correlation model may generate recommended mitigation activities for an incident class that are similar to the historical mitigation activities that correspond to a similar incident class. For example, if the trained classification model generates a pumped off ESP incident class, the correlation model may generate mitigation activities that are similar to the historical mitigation activities corresponding to a pumped off ESP incident within the plurality of historical mitigation activities. The correlation model may generate one or more recommended mitigation activities. For example, the correlation model may generate recommended mitigation activities including decreasing the motor speed and downsizing the ESP for an incident class of low intake pressure.

At block 314, a wellbore operation may be performed based on the recommended mitigation activities and updated alarm. For example, with reference to FIG. 1, a processor of the computer 170 may perform this operation. The wellbore operations may include the recommended mitigation activities. For example, the recommended mitigation activities of increasing the motor speed and downsizing the ESP may have been generated. A wellbore operation of increasing the motor speed may be performed on the ESP based on the recommended mitigation activities. In some embodiments, the wellbore operation may not be a recommended mitigation activity. For example, the recommended mitigation activity may include adjusting the motor speed, and a different wellbore operation may be performed instead. In some embodiments, the alarm may indicate the urgency in which the wellbore operation may be performed. For example, an alarm with a high severity may indicate that the recommended mitigation activities be performed before additional damage is incurred on the ESP. In some embodiments, wellbore operations may be performed without the recommended mitigation activities. For instance, wellbore operations may be performed on the ESP and associated wellbore when an alarm is not generated and/or when no recommended mitigation activities are generated by the correlation model via the trained classification model. In some embodiments, no wellbore operations may be performed when a recommended mitigation activity is generated. For instance, the recommended mitigation activity may be used for informational purposes (i.e., reported to an operator, added to the plurality of historical mitigation activities, etc.) and a wellbore operation may not be performed on the ESP and/or wellbore after the recommended mitigation activity is generated.

FIG. 4 depicts a flowchart of example operations for configuring a classification machine learning model, according to some embodiments. Operations of the flowchart 400 of FIG. 4 are described in reference to the computer 170 of FIG. 1. The computer 170 may perform any or all of the operations described with reference to FIG. 4. Operations of the flowchart 400 start at block 402.

At block 402, a feature set may be determined for a classification machine learning model. For example, with reference to FIG. 1, a processor of the computer 170 may perform this determination. The feature set may include ESP data. The ESP data may include operation parameters, equipment parameters (i.e., ESP sizing information), and performance parameters. As noted in FIG. 2, ESP data can be obtained in the time domain via the sensor and the controller. Some implementations may utilize any suitable feature set including any suitable value related to the ESP and reservoir models related to the well.

At block 404, the classification machine learning model may be configured to receive the feature set as input. For example, with reference to FIG. 1, a processor of the computer 170 may perform this operation. For example, the learning machine may include a neural network, such as a convolutional neural network, that includes an input layer, one or more hidden layers, and an output layer. Each layer may include one or more neurons. In some implementations, one or more neurons of the input layer are configured to receive the features as input. As noted, the features may include ESP data. Additionally, the classification model may include a decision tree where each branching may represent values or normalized values of the features. Each leaf may indicate an incident type.

After block 404, the learning machine begins training itself based on training samples. The discussion of FIG. 5 provides additional details about training samples and training the learning machine.

FIG. 5 depicts a flowchart of example operations for training a classification machine learning model, according to some embodiments. Operations of the flowchart 500 of FIG. 5 are described in reference to the computer 170 of FIG. 1. The computer 170 may perform any or all of the operations described with reference to FIG. 5. Operations of the flowchart 500 start at block 502.

At block 502, historical ESP data may be obtained from a plurality of ESPs. For example, with reference to FIG. 1, a processor of the computer 170 may perform this operation. The historical ESP data may include performance parameters corresponding to operation parameters and equipment parameters associated with an ESP over a period of time. For instance, a subset of the historical ESP data may include the operation parameters and performance parameters over a 1-hour time period for a specific sized ESP. The historical ESP data may include data from different sized ESPs and ESPs positioned in different subsurface formations. In some embodiments, at least a portion of the historical ESP data may be in the time domain. For example, the operation parameters and corresponding performance parameters may be a time series of data. In some embodiments, at least a portion of the historical ESP data may be categorical data. For example, the equipment parameters may be categorical data.

At block 504, features may be extracted from the historical ESP data. For example, with reference to FIG. 1, a processor of the computer 170 may perform this operation. Features may include standard deviation, kurtosis, skewness, etc. within the historical ESP data. For instance, features may be extracted from performance parameters from a 1-hour time period of the historical ESP data to generate a representative categorical feature set.

At block 506, the extracted features may be processed to generate a processed dataset. For example, with reference to FIG. 1, a processor of the computer 170 may perform this operation. The processed dataset may include processing the extracted features to remove outliers and formatting the extracted features such that they may be acceptable as input for a machine learning model. Processing the extracted features may include smoothing the extracted features to remove outlier data. For example, data points above or below a threshold may not be included in the processed dataset or a moving average may be used instead of the actual values. Processing the extracted features may also include dimension reduction utilizing techniques such as principal component analysis (PCA). For instance, the PCA may be performed on the extracted feature set. A threshold for explained variance may determine a cutoff for the number of principal components to use as input for the machine learning model.

At block 508, the processed dataset may be input into a machine learning model. For example, with reference to FIG. 1, a processor of the computer 170 may perform this operation. In some embodiments, the machine learning model may include clustering, such as unsupervised clustering. The unsupervised clustering machine learning model may be configured to accept features including categorical features and/or a processed feature set of time series data created from operation parameters, equipment parameters, and performance parameters. The unsupervised clustering machine learning model may be configured to generate clusters based on the processed dataset. The unsupervised clustering machine learning model may use methods including k-means clustering, hierarchical clustering, etc. to generate the clusters.

At block 510, clusters may be generated with the machine learning model based on the processed dataset. For example, with reference to FIG. 1, a processor of the computer 170 may perform this operation. A cluster may include a plurality of extracted features that may be related. For instance, performance parameters with corresponding operation parameters and equipment parameters may be grouped into a cluster with similar performance parameters corresponding to similar operation parameters and equipment parameters. For example, a cluster may include 250 HP, 5.5-inch ESPs (equipment parameters) operating at an average of 55 Hz over a 1-hour time period (operating parameters) with an internal motor temperature ranging between 220 degrees Fahrenheit and 240 degrees Fahrenheit (performance parameters). A cluster may also be created based on variability and trends in the data. For example, multiple clusters may exist with the same equipment parameters but with different levels of variability or with a consistent downward or upward trend in time series data over a 1-hour time period.

At block 512, training samples may be generated by labelling each of the clusters with an incident class. For example, with reference to FIG. 1, a processor of the computer 170 may perform this operation. In some embodiments, the clusters may be manually labelled with an incident class by engineers, operators, etc. Each of the training samples may include a cluster and a corresponding incident class.

At block 514, the classification machine learning model may be trained based on the training samples. For example, with reference to FIG. 1, a processor of the computer 170 may perform this operation. As noted, the classification machine learning model may include a neural network. In some implementations, the classification machine learning model may process the training samples and perform backpropagation to minimize a cost function for the neural network. The classification machine learning model may use fewer than all the training samples in its training process. For example, the learning machine may utilize 80% of the training samples at block 306. Later, the learning machine may use the remaining 20% of the training samples to validate the classification machine learning model.

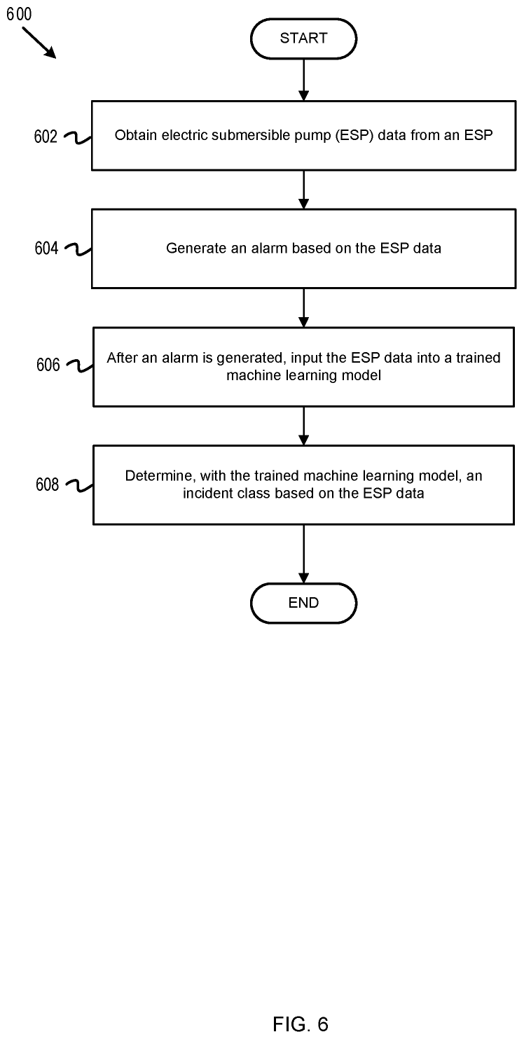

FIG. 6 depicts a flowchart of example operations for determining an incident class, according to some embodiments. Operations of the flowchart 600 of FIG. 6 are described in reference to the computer 170 of FIG. 1. The computer 170 may perform any or all of the operations described with reference to FIG. 6. Operations of the flowchart 600 start at block 602.

At block 602, electric submersible pump (ESP) data may be obtained from an ESP. For example, with reference to FIG. 1, a processor of the computer 170 may perform this operation.

At block 604, an alarm may be generated based on the ESP data. For example, with reference to FIG. 1, a processor of the computer 170 may perform this operation.

At block 606, the ESP data may be input into a trained machine learning model after an alarm is generated. For example, with reference to FIG. 1, a processor of the computer 170 may perform this operation.

At block 608, the trained machine learning model may determine an incident class based on the ESP data. For example, with reference to FIG. 1, a processor of the computer 170 may perform this operation.

### Example Computer

FIG. 7 depicts an example computer, according to some embodiments. FIG. 7 depicts a computer 700 that includes a processor 701 (possibly including multiple processors, multiple cores, multiple nodes, and/or implementing multi-threading, etc.). The computer 700 includes a memory 707. The memory 707 may be system memory or any one or more of the above already described possible realizations of machine-readable media. The computer 700 also includes a bus 703 and a network interface 705.

The computer 700 also includes an anomaly monitoring and mitigation recommendation engine 711 and a controller 715. The anomaly monitoring and mitigation recommendation engine 711 and the controller 715 can perform one or more of the operations described herein. For example, the anomaly monitoring and mitigation recommendation engine 711 may be configured to generate an alarm if an anomaly is detected in the ESP system. Additionally, the anomaly monitoring and mitigation recommendation engine 711 may generate recommended activities to mitigate the anomaly. The controller 715 can perform various control operations to a wellbore operation based on the output from the processor 701. For example, the controller 715 can perform an operation based on the alarm and recommended mitigation activities.

Any one of the previously described functionalities may be partially (or entirely) implemented in hardware and/or on the processor 701. For example, the functionality may be implemented with an application specific integrated circuit, in logic implemented in the processor 701, in a co-processor on a peripheral device or card, etc. Further, implementations may include fewer or additional components not illustrated in FIG. 7 (e.g., video cards, audio cards, additional network interfaces, peripheral devices, etc.). The processor 701 and the network interface 705 are coupled to the bus 703. Although illustrated as being coupled to the bus 703, the memory 707 may be coupled to the processor 701.

While the aspects of the disclosure are described with reference to various implementations and exploitations, these aspects are illustrative and the scope of the claims is not limited to them. In general, techniques for utilizing machine learning for detecting anomalies and generating recommended mitigation activities may be implemented with facilities consistent with any hardware system or hardware systems. Many variations, modifications, additions, and improvements are possible.

Plural instances may be provided for components, operations or structures described herein as a single instance. Boundaries between various components, operations, and data stores may differ from those described herein. Particular operations may be illustrated in the context of specific example configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

This description includes example systems, methods, techniques, and program flows that embody aspects of the disclosure. However, this disclosure may be practiced without these specific details. For instance, this disclosure refers to features of a feature set of independent variables that may equipment parameters, operation parameters, and performance parameters. Aspects of this disclosure can also be applied to any other types of features. In other instances, well-known instruction instances, protocols, structures, and techniques have not been shown in detail in order not to obfuscate the description.

### Example Implementations

Embodiment #1: A computer-implemented method for monitoring an electrical submersible pump (ESP) disposed in a wellbore, the method comprising: obtaining ESP data from the ESP; generating an alarm based on the ESP data; and performing the following after the alarm is generated, inputting the ESP data into a trained machine learning model; and determining, with the trained machine learning model, an incident class based on the ESP data.

Embodiment #2: The method of Embodiment #1 further comprising: determining at least one mitigation activity from a plurality of historical mitigation activities based on the incident class.

Embodiment #3: The method of Embodiment #2 further comprising: wherein determining the at least one mitigation activity comprises inputting the incident class and the plurality of historical mitigation activities into a correlation model to determine the at least one mitigation activity.

Embodiment #4: The method of Embodiments #1 or #2 further comprising: updating the alarm based on the incident class.

Embodiment #5: The method of any one or more of Embodiments #1-4, further comprising: separating recent ESP behavior from at least a portion of the ESP data to generate a training dataset; inputting the training dataset into a forecasting model to determine a predicted ESP behavior; generating an ESP health score based on a comparison of the recent ESP behavior and the predicted ESP behavior, wherein the comparison is based on attributes including a prediction interval and distance metrics; and generating the alarm based on the ESP health score.

Embodiment #6: The method of any one or more of Embodiments #1-5 further comprising: determining, for a first machine learning model, a feature set, wherein the feature set includes an ESP data feature; configuring the first machine learning model to receive the feature set as input; generating training samples; and training the first machine learning model based on the training samples to generate the trained machine learning model, wherein each training sample includes an incident class sample that is associated with at least one cluster sample.

Embodiment #7: The method of Embodiment #6, wherein generating the training samples further comprises: obtaining a historical ESP data sample; generating a processed dataset based on the historical ESP data sample; inputting the processed dataset into a second machine learning model; generating, with the second machine learning model, at least one cluster sample based on the processed dataset; and labelling each of the at least one cluster samples with an incident class sample to generate the training samples.

Embodiment #8: The method of Embodiment #7, wherein the second machine learning model comprises unsupervised clustering.

Embodiment #9: A non-transitory computer-readable medium including computer-executable instructions comprising: instructions to obtain ESP data from an electrical submersible pump (ESP) disposed in a wellbore; instructions to generate an alarm based on the ESP data; and instructions to perform the following in response to the alarm being generated, input the ESP data into a trained machine learning model; and determine, with the trained machine learning model, an incident class based on the ESP data.

Embodiment #10: The non-transitory computer-readable medium of Embodiment #9 further comprising: instructions to determine at least one mitigation activity from a plurality of historical mitigation activities based on the incident class.

Embodiment #11: The non-transitory computer-readable medium of Embodiment #10 further comprising: wherein determining the at least one mitigation activity comprises inputting the incident class and the plurality of historical mitigation activities into a correlation model to determine the at least one mitigation activity.

Embodiment #12: The non-transitory computer-readable medium of Embodiments #9 or #10 further comprising: instructions to update the alarm based on the incident class.

Embodiment #13: The non-transitory computer-readable medium of any one or more of Embodiments #9-12 further comprising: instructions to separate recent ESP behavior from at least a portion of the ESP data to generate a training dataset; instruction to input the training dataset into a forecasting model to determine a predicted ESP behavior; instructions to generate an ESP health score based on a comparison of the recent ESP behavior and predicted ESP behavior, wherein the comparison is based on attributes including a prediction interval and distance metrics; and instructions to generate the alarm based on the ESP health score.

Embodiment #14: The non-transitory computer-readable medium of any one or more of Embodiments #9-13 further comprising: instructions to determine, for a first machine learning model, a feature set, wherein the feature set includes an ESP data feature; instructions to configure the first machine learning model to receive the feature set as input; instructions to generate training samples; and instructions to train the first machine learning model based on the training samples to generate the trained machine learning model, wherein each training sample includes an incident class sample that is associated with at least one cluster sample.

Embodiment #15: The non-transitory computer-readable medium of Embodiment #14, wherein the instructions to generate the training samples include: instructions to obtain a historical ESP data sample; instructions to generate a processed dataset based on the historical ESP data sample; instructions to input the processed dataset into a second machine learning model; instructions to generate, with the second machine learning model, at least one cluster sample based on the processed dataset; and instructions to label each of the at least one cluster samples with an incident class sample to generate the training samples.

Embodiment #16: A system comprising: an electrical submersible pump (ESP) to be disposed in a wellbore; a processor; and a computer-readable medium having instructions stored thereon that are executable by the processor, the instructions including instructions to obtain ESP data from the ESP; instructions to generate an alarm based on the ESP data; and instructions to perform the following in response to the alarm being generated, input the ESP data into a trained machine learning model; and determine, with the trained machine learning model, an incident class based on the ESP data.

Embodiment #17: The system of Embodiment #16, wherein the instructions include: instructions to determine at least one mitigation activity from a plurality of historical mitigation activities based on the incident class.

Embodiment #18: The system of Embodiments #16 or #17, wherein the instructions include: instructions to separate recent ESP behavior from at least a portion of the ESP data to generate a training dataset; instructions to input the training dataset into a forecasting model to determine a predicted ESP behavior; instructions to generate an ESP health score based on a comparison of the recent ESP behavior and predicted ESP behavior, wherein the comparison is based on attributes including a prediction interval and distance metrics; and instructions to generate the alarm based on the ESP health score.

Embodiment #19: The system of any one or more of Embodiments #16-18, wherein the instructions include: instructions to determine, for a first machine learning model, a feature set, wherein the feature set includes an ESP data feature; instructions to configure the first machine learning model to receive the feature set as input; and instructions to generate training samples; and instructions to train the first machine learning model based on the training samples to generate the trained machine learning model, wherein each training sample includes an incident class sample that is associated with at least one cluster sample.

Embodiment #20: The system of Embodiment #19, wherein the instructions to generate the training samples include: instructions to obtain a historical ESP data sample; instructions to generate a processed dataset based on the historical ESP data sample; instructions to input the processed dataset into a second machine learning model; instructions to generate, with the second machine learning model, at least one cluster sample based on the processed dataset; and instructions to label each of the at least one cluster samples with an incident class sample to generate the training samples.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

1. A computer-implemented method for monitoring an electrical submersible pump (ESP) disposed in a wellbore, the method comprising:
obtaining ESP data from the ESP;
generating an alarm based on the ESP data; and
performing the following after the alarm is generated,
inputting the ESP data into a trained machine learning model; and
determining, with the trained machine learning model, an incident class based on the ESP data.

2. The method of claim 1 further comprising:
determining at least one mitigation activity from a plurality of historical mitigation activities based on the incident class.

3. The method of claim 2 further comprising:
wherein determining the at least one mitigation activity comprises inputting the incident class and the plurality of historical mitigation activities into a correlation model to determine the at least one mitigation activity.

4. The method of claim 1 further comprising:
updating the alarm based on the incident class.

5. The method of claim 1, further comprising:
separating recent ESP behavior from at least a portion of the ESP data to generate a training dataset;
inputting the training dataset into a forecasting model to determine a predicted ESP behavior;
generating an ESP health score based on a comparison of the recent ESP behavior and the predicted ESP behavior, wherein the comparison is based on attributes including a prediction interval and distance metrics; and
generating the alarm based on the ESP health score.

6. The method of claim 1 further comprising:
determining, for a first machine learning model, a feature set, wherein the feature set includes an ESP data feature;
configuring the first machine learning model to receive the feature set as input;
generating training samples; and
training the first machine learning model based on the training samples to generate the trained machine learning model, wherein each training sample includes an incident class sample that is associated with at least one cluster sample.

7. The method of claim 6, wherein generating the training samples further comprises:
obtaining a historical ESP data sample;
generating a processed dataset based on the historical ESP data sample;
inputting the processed dataset into a second machine learning model;
generating, with the second machine learning model, at least one cluster sample based on the processed dataset; and
labelling each of the at least one cluster samples with an incident class sample to generate the training samples.

8. The method of claim 7, wherein the second machine learning model comprises unsupervised clustering.

9. A non-transitory computer-readable medium including computer-executable instructions comprising:
instructions to obtain ESP data from an electrical submersible pump (ESP) disposed in a wellbore;
instructions to generate an alarm based on the ESP data; and
instructions to perform the following in response to the alarm being generated,
input the ESP data into a trained machine learning model; and
determine, with the trained machine learning model, an incident class based on the ESP data.

10. The non-transitory computer-readable medium of claim 9 further comprising:
instructions to determine at least one mitigation activity from a plurality of historical mitigation activities based on the incident class.

11. The non-transitory computer-readable medium of claim 10 further comprising:
wherein determining the at least one mitigation activity comprises inputting the incident class and the plurality of historical mitigation activities into a correlation model to determine the at least one mitigation activity.

12. The non-transitory computer-readable medium of claim 9 further comprising:
instructions to update the alarm based on the incident class.

13. The non-transitory computer-readable medium of claim 9 further comprising:
instructions to separate recent ESP behavior from at least a portion of the ESP data to generate a training dataset;
instruction to input the training dataset into a forecasting model to determine a predicted ESP behavior;
instructions to generate an ESP health score based on a comparison of the recent ESP behavior and predicted ESP behavior, wherein the comparison is based on attributes including a prediction interval and distance metrics; and
instructions to generate the alarm based on the ESP health score.

14. The non-transitory computer-readable medium of claim 9 further comprising:
instructions to determine, for a first machine learning model, a feature set, wherein the feature set includes an ESP data feature;
instructions to configure the first machine learning model to receive the feature set as input;
instructions to generate training samples; and
instructions to train the first machine learning model based on the training samples to generate the trained machine learning model, wherein each training sample includes an incident class sample that is associated with at least one cluster sample.

15. The non-transitory computer-readable medium of claim 14, wherein the instructions to generate the training samples include:
instructions to obtain a historical ESP data sample;
instructions to generate a processed dataset based on the historical ESP data sample;
instructions to input the processed dataset into a second machine learning model;
instructions to generate, with the second machine learning model, at least one cluster sample based on the processed dataset; and
instructions to label each of the at least one cluster samples with an incident class sample to generate the training samples.

16. A system comprising:
an electrical submersible pump (ESP) to be disposed in a wellbore;
a processor; and
a computer-readable medium having instructions stored thereon that are executable by the processor, the instructions including
instructions to obtain ESP data from the ESP;
instructions to generate an alarm based on the ESP data; and
instructions to perform the following in response to the alarm being generated,
input the ESP data into a trained machine learning model; and
determine, with the trained machine learning model, an incident class based on the ESP data.

17. The system of claim 16, wherein the instructions include:
instructions to determine at least one mitigation activity from a plurality of historical mitigation activities based on the incident class.

18. The system of claim 16, wherein the instructions include:
instructions to separate recent ESP behavior from at least a portion of the ESP data to generate a training dataset;
instructions to input the training dataset into a forecasting model to determine a predicted ESP behavior;
instructions to generate an ESP health score based on a comparison of the recent ESP behavior and predicted ESP behavior, wherein the comparison is based on attributes including a prediction interval and distance metrics; and
instructions to generate the alarm based on the ESP health score.

19. The system of claim 16, wherein the instructions include:
instructions to determine, for a first machine learning model, a feature set, wherein the feature set includes an ESP data feature;
instructions to configure the first machine learning model to receive the feature set as input; and
instructions to generate training samples; and
instructions to train the first machine learning model based on the training samples to generate the trained machine learning model, wherein each training sample includes an incident class sample that is associated with at least one cluster sample.

20. The system of claim 19, wherein the instructions to generate the training samples include:
instructions to obtain a historical ESP data sample;
instructions to generate a processed dataset based on the historical ESP data sample;
instructions to input the processed dataset into a second machine learning model;
instructions to generate, with the second machine learning model, at least one cluster sample based on the processed dataset; and
instructions to label each of the at least one cluster samples with an incident class sample to generate the training samples.
